(19) United States
(12) Patent Application Publication
(10) Pub. No.: US 2010/0089108 A1
(43) Pub. Date: Apr. 15, 2010

(54) LOCK APPARATUS AND METHOD OF USE

(76) Inventors: Kane Dutt, Reno, NV (US); Jeffrey S. Sunderman, Reno, NV (US); Keith Wertz, Carson City, NV (US); Bruce Sanguinetti, Genoa, NV (US); Mike Johnson, Danville, CA (US)

Correspondence Address: HOLLAND & HART, LLP, P.O BOX 8749, DENVER, CO, 80201, US

(21) Appl. No.: 12/463,286

(22) Filed: May 8, 2009

Related U.S. Application Data
(60) Provisional application No. 61/051,617, filed on May 8, 2008.
(60) Provisional application No. 61/170,523, filed on Apr. 17, 2009.

(51) Int. Cl. E05B 49/00; B62H 5/00; G07F 5/00

(52) U.S. Cl. 70/278.7; 70/234; 194/217

(57) ABSTRACT

Embodiments of a lock apparatus for securing an article, such as a cycle frame, and methods of use of a lock apparatus are presented.

### PRIORITY STATEMENT

The present application claims priority to U.S. Provisional Application No. 61/051,617, filed May 8, 2008 entitled LOCK APPARATUS AND METHOD OF USE, to U.S. Provisional Application No. 61/170,523, filed Apr. 17, 2009 entitled LOCK APPARATUS, METHOD OF USE AND PARKING MANAGEMENT SYSTEM. The contents of these applications and U.S. patent application Ser. No. 11/661,545, PCT Number PCT/US05/31392, filed Sep. 1, 2005 entitled LOCK APPARATUS AND METHOD OF USE are incorporated herein by reference.

### BACKGROUND

Bicycle theft, and other types of cycle theft, have long presented very significant and widely recognized problems. These problems arise not only when cycles are in use but also when in storage or during transport of cycles from one place to another.

Common cycle locking apparatus include padlocks, chains, wirelocks, and U-locks. These types of locking apparatus are typically portable and secure a portion of a cycle, such as a wheel or the frame, to another object, such as a tree, bike rack, fence, etc.

These types of devices can be effective in preventing theft. They can be particularly unreliable or difficult to use, however, when a cycle is stored or transported. For example, when stored in a garage, the user often has difficulty finding an effective object to which a cycle may be securely locked with these types of apparatus. In addition, locking a cycle with these types of devices requires substantial time and effort by the user to orient the cycle in position, mount the separate lock on the cycle and other object, lock the separate lock, and then, when desired for reuse of the cycle, unlock the separate lock with a key or combination and then reversing the process. The user may often forget to lock the cycle in position or simply chose to refrain from locking the cycle in position due to time constraints, a false sense of security, or a variety of other circumstances.

One solution has been to provide a cycle rack mounted to a wall. The user mounts the cycle on the rack and then utilizes a lock, such as a padlock, chain, or wire lock, or U-lock, to lock the cycle on the fixed rack. These types of racks are usually relatively easily removed from the associated wall, however, such as by removing the exposed fasteners securing the rack to the wall. In addition, these types of racks typically still require the user to first mount the cycle on the rack, then mount the separate lock to the rack, lock the separate lock, and then, when desired for use or transport of the cycle, unlock the separate lock with a key or combination and perform the reverse, time consuming, de-mounting of the lock prior to removal of the cycle from the rack. Again, the user may often fail to lock the cycle to the rack due to the time and effort required to lock and unlock the cycle to the rack.

One prior art device provides a cycle-wheel-locking clamp that mounts to a wall or other object. The user locks the cycle in position by positioning a wheel rim within the clamp, closing the clamp around the wheel rim, and then locking the clamp in position with a separate padlock. Again, the user must store and utilize a separate padlock, and only the cycle's wheel is really secured in position. A thief can steal the balance of the cycle by, for example, disconnecting the wheel from the cycle frame.

U.S. Pat. No. 6,057,657 entitled “Magnetically Operated Bicycle Antitheft Device,” to Kitamura et al, discloses bicycle locks that are activated to unlock by magnetic or wireless controls. Although this reference discloses locks that open more quickly than conventional keyed or combination locks, this reference does not otherwise disclose how to solve problems by, among other things, reliably ensuring locking of cycle in position when storing or transporting a cycle.

Additional information may be found in the following references: U.S. Pat. No. 5,945,794, entitled “Power Saving Antitheft Control Device for a Bicycle,” to Kitamura; U.S. Pat. No. 5,917,407, entitled “Unattended Automatic Bicycle Rental Station,” to Squire et al; U.S. Pat. No. 5,836,002, entitled “Anti-Theft Device,” to Morstein et al; U.S. Pat. No. 5,278,538, entitled “Bicycle Security System” to Ainsworth et al; and U.S. Pat. No. 4,920,334, entitled “Security System for Bicycles, Ski Racks and Coat Racks,” to DeVolpi.

### SUMMARY

This Summary is provided to introduce a selection of concepts in a simplified form that are further described below in the Detailed Description. This Summary, and the foregoing Background, is not intended to identify key aspects or essential aspects of the claimed subject matter. Moreover, this Summary is not intended for use as an aid in determining the scope of the claimed subject matter.

A lock apparatus and methods of using and fabricating the same are presented. The lock apparatus will provide users with storage and security options for a wide array of various articles that may include cycles, skis, fishing tackle, rifles, shotguns, and the like.

In various embodiments, the lock apparatus may be provided with one or more lock assemblies. The lock assemblies, in some embodiments, may be provided in the form of jaw structures that are capable of being moved between closed and opened positions. A lower frame member may be provided as a central support member for the lock assembly. A rear wall extends upwardly from a rearward portion of the bottom wall and may enable the lower frame member to be mounted with a back plate mount. In some embodiments, the rear wall may be operatively coupled with a rear spacer mount. An upper frame member may be pivotably coupled with the lower frame member, allowing the structures to move between open and closed positions with respect to one another. In some embodiments, a lower mounting plate is positioned adjacent the lower frame member and supports many of the structures responsible for moving the lock assembly between open and closed positions. Accessory engagement members may be positioned adjacent forward end portions of the lock assembly to secure portions of the accessories when the lock assembly is urged into a closed position.

In some embodiments, a drive screw is rotatably mounted within the locking assembly for selective rotation in opposite directions. Such movement advances and withdrawals a follower block that is threadably engaged with the drive screw. In some embodiments, sliding engagement between the follower block an upper sub-carriage plate moves the lock assembly between its open and closed positions. An electric motor may be associated with the drive screw to automate the opening and closing of the lock apparatus.

In some embodiments, a strain gauge may be associated with either or both of the article supports. In at least one embodiment, the strain gauge to detect forces exerted between the article supports. Such force readings taken by the strain gauge may be relayed to a processor associated with the lock apparatus. In some embodiments, software associated with the processor will operate the opening and closing of the lock assembly, either according to a manual selection by the user or by an automated response to an article being disposed between the article supports. Measurements of the force taken by the strain gauge may be relayed to the processor, which may then be programmed to actuate the electric motor and close the lock assembly around the article disposed between the article supports. Conversely, if a user suddenly removes the article from between the article supports, the strain gauge may be provided to detect a lessening of the force and direct the electric motor to stop or reverse direction.

Various embodiments of the lock apparatus provide at least one support member to which one or more lock assemblies may be secured. In some embodiments, the support member is provided in the form of an elongated pole. In at least one embodiment, one end of the support member is secured with a ground surface, such as a sidewalk, parking lot, garage floor, or other commonly encountered commercial, public or private spaces in which articles such as cycles may be stored temporarily or long term. In some embodiments, the lock apparatus may leave an opposite end of the support member in a position that is unsecured within a neighboring structure. In other embodiments, an extension arm may be provided to be coupled with the free end portion of the support member. An opposite end of the extension arm may be secured with a static structure, such as a wall. In various embodiments, a hub member is provided to secure the free ends of multiple support members with one another.

In various embodiments, the support member, extension arm, and support frame may be formed from various diameters of tubing, having an open internal passageway extending between the end portions thereof. In such embodiments, electrical lines, communication network lines and the like, may be provided to extend outwardly from a building or from a ground surface to properly supply a lock apparatus with necessary power and communications access.

Different embodiments of the support members provide for various lengths of support members. In various embodiments, the support member may be provided in a length that enables a two level securement of articles, such as cycles. Multiple lock assemblies may be associated with different side portions of each support member, simultaneously.

In various embodiments, a tether may be associated with the lock assembly. In some embodiments, the tether may be provided with opposite end portions, with one end being secured with either the lock assembly or an adjacent structure, such as the support member. In at least one embodiment, the opposite end portion of the tether will be selectively securable with either a portion of the lock assembly or an adjacent structure, such as the support member. It is contemplated that the tether may be comprised of a rigid cable of durable material, such as braided steel and the like. However, in other embodiments, an electrical line may be disposed to run the length of the tether that is coupled with a power supply to the lock apparatus. The electrical line may further be electrically coupled with one or more processors associated with the lock apparatus. In such arrangements, the processor may be provided with software that is capable of reading a current or “open line” condition of the electrical line. The software may be provided to relay an alarm warning where power is no longer provided to the electrical line within the tether or that the electrical line within the tether has been severed. It is contemplated that the tether may be provided with a length that allows users to easily secure separate articles therewith. In some embodiments, users may secure bike helmets, bike seats, wheels, and the like thereto.

In some embodiments, a pay point may be associated with the lock apparatus. In particular embodiments, the pay point provides users with an input device, to receive data from the user, and a display for presenting information and feedback to the user. In still other embodiments, the pay point may include an electromagnetic card reader and associated sensors to enable the pay point to read the magnetic strips commonly found on credit cards, ID cards, proprietary cards, and the like. In some embodiments, software may be associated with the processor to determine that a particular validated identification is received from a user. In some instances, the validation may come in the form of a payment from a creditor debit card. In other instances, the validation may come from a proprietary card associated with an operator of the lock apparatus. Such validation may cause the software to send a signal to a lock assembly, causing the jaws of the lock assembly to open. In this scenario, a user may then place an article between the article supports and, where a strain gauge is used, causing the lock assembly to automatically close and secure the article therein. Alternatively or in addition to the described functions for the pay point, authentication from one or more users may be entered into the pay point through the use of one or more biometric sensors.

Various embodiments of the lock apparatus will incorporate one or more different security measures to protect against the theft of articles stored by the lock apparatus. In some embodiments, sensors may be associated with one or more components of the lock apparatus, including one or more vibration sensors, simple “open and closed” switch sensors, and “power available” sensors. Irrespective of the type of security sensor used, each such sensor will produce an anomaly or warning signal. A processor that is associated with a network connection that enables the lock apparatus to transmit signals to remote locations may receive the signals from the sensors and relay warnings and other data to users of the lock apparatus or even the police, or other security agency.

In various embodiments, the security systems afforded to the lock apparatus may provide local alarm notification along with, or alternative to, the transmission of anomalies or warning signals to a remote location. In at least one embodiment, a visual warning system, such as a strobe light or other light emitting source, may be coupled with the lock apparatus. Similarly, an audible alarm, such as a siren or the like, may be associated with the lock apparatus by electrically coupling a horn or other speaker with a central processor that receives the anomalies or warning signals. In still another embodiment, the security circuitry associated with the lock apparatus may be provided to disable the electric motor. It is further contemplated that still or video surveillance of the area associated with the lock apparatus may be provided; such surveillance may be recorded and/or provided as a live feed to one or more monitoring stations remote from the lock apparatus.

It can thus be seen that the foregoing cycle lock apparatus provides both cycle storage and security in one apparatus. The apparatus is relatively easy to use, strong, long lasting, and economical and easy to manufacture, install, or re-install if needed. It can help reduce the possibility of damage to an associated cycle when mounted in the apparatus, even when the apparatus is subject to tampering. It also provides alarms for various types of tampering or possible damage to the apparatus or associated cycle, and the alarms may be contained within the apparatus or provided by separate alarm systems, such as a building alarm system with which the apparatus may readily be adapted to communicate, including wirelessly, if desired. In addition, the cycle lock apparatus may provide a convenient and reliable support for working with or maintaining a cycle mounted in the apparatus.

Features of the present disclosure can include methods of use of the disclosed apparatus or other apparatus that may provide the process(es) of the one or more such methods.

These and other aspects of the present system and method will be apparent after consideration of the Detailed Description and Figures herein. It is to be understood, however, that the scope of the invention shall be determined by the claims as issued and not by whether given subject matter addresses any or all issues noted in the Background or includes any features or aspects recited in this Summary.

### DRAWINGS

Non-limiting and non-exhaustive embodiments of the present invention, including the preferred embodiment, are described with reference to the following figures, wherein like reference numerals refer to like parts throughout the various views unless otherwise specified.

FIG. 1 dictates one embodiment of the lock apparatus and demonstrates one manner in which a plurality of cycles may be secured thereto and further demonstrates one manner in which the lock apparatus may be simultaneously secured with a vertical structure, such as the wall of a building, and a horizontal surface, such as a ground surface.

FIG. 2 depicts a perspective view of one embodiment of a lock assembly in a closed position.

FIG. 3 depicts the lock assembly of FIG. 2 as the same may be placed in an open position for receiving one or more articles to be secured.

FIG. 4 depicts a side, perspective view of one embodiment of a lock assembly and a number of its internal components as they may be operatively coupled with one another.

FIG. 5 depicts an exploded view of the lock assembly depicted in FIG. 4.

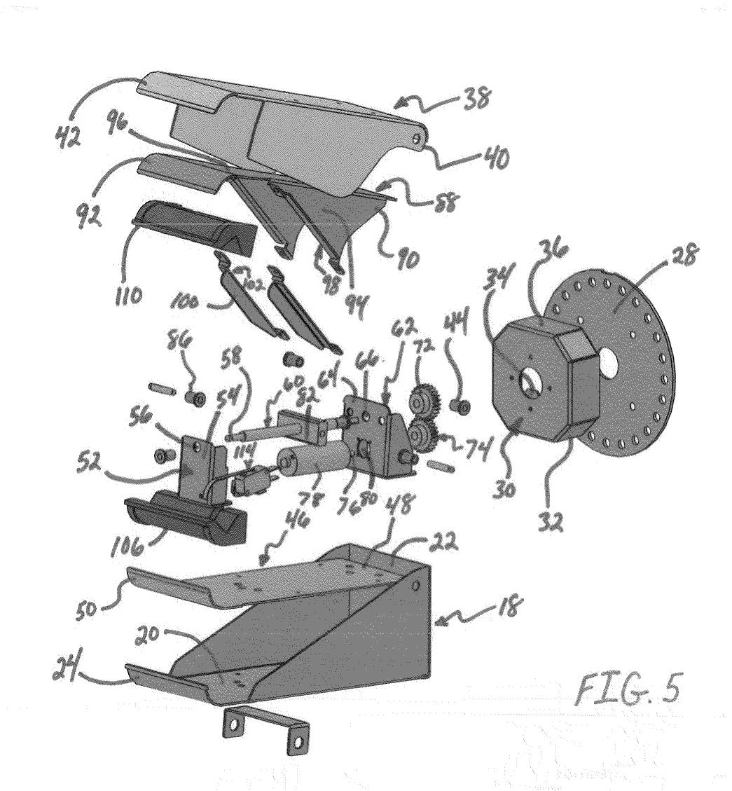

FIG. 6, an engineering spec sheet for one embodiment of a lower frame member of a lock assembly that may be used with the lock apparatus.

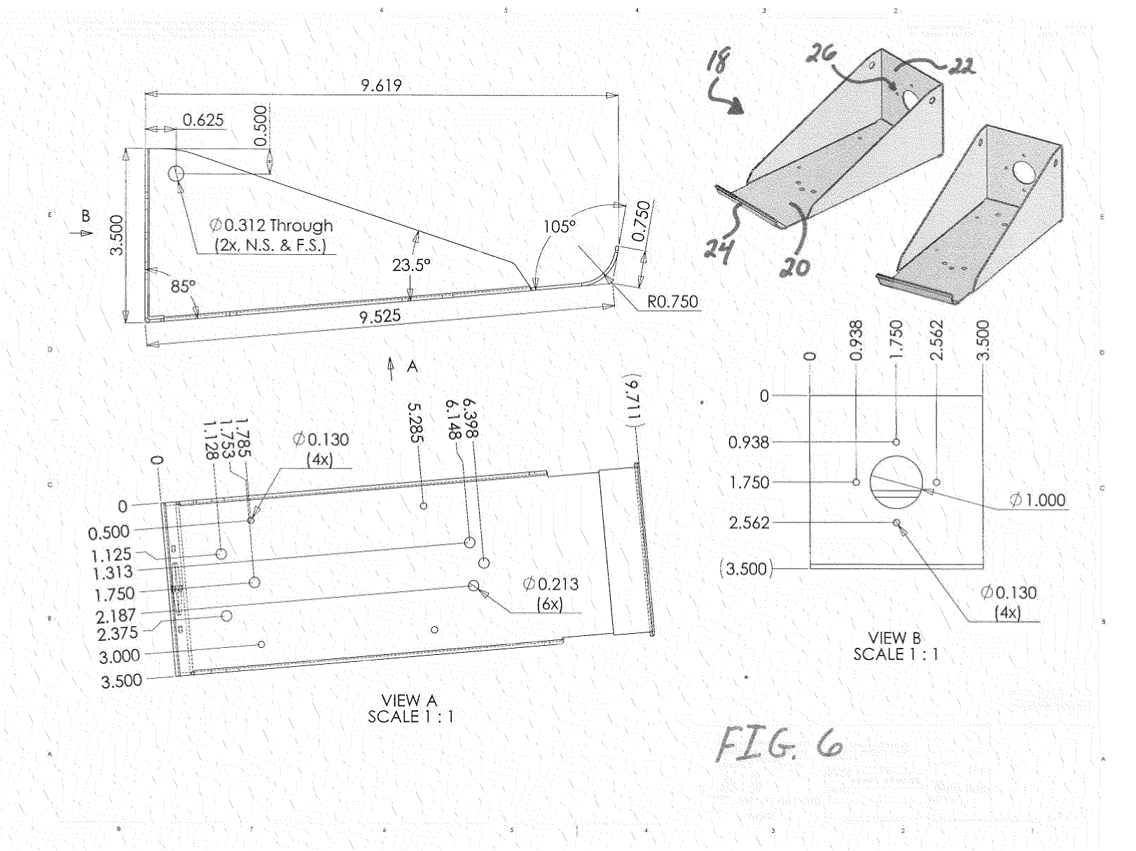

FIG. 7 depicts an engineering spec sheet for one embodiment of a top sub-carriage of a lock assembly that may be used with the lock apparatus.

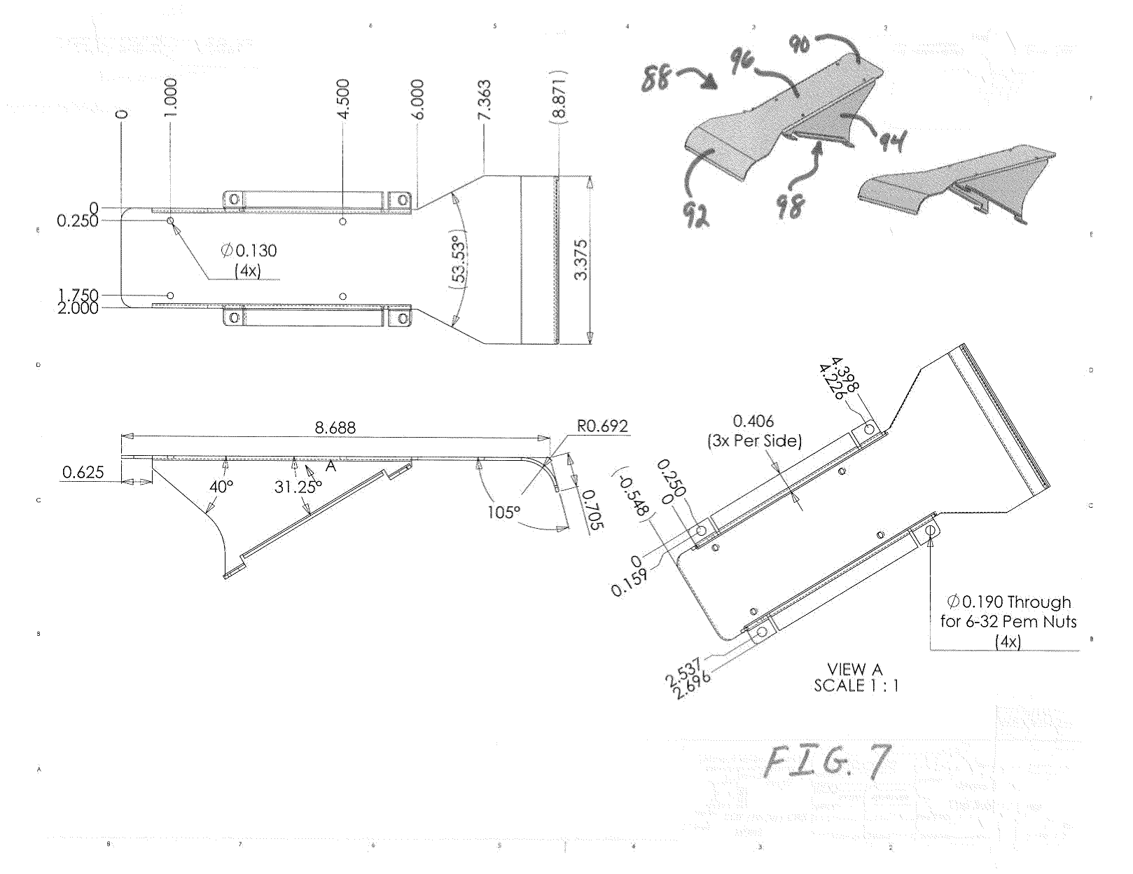

FIG. 8 depicts an engineering spec sheet of one embodiment of a follower keeper bracket for a lock assembly that may be used with the lock apparatus.

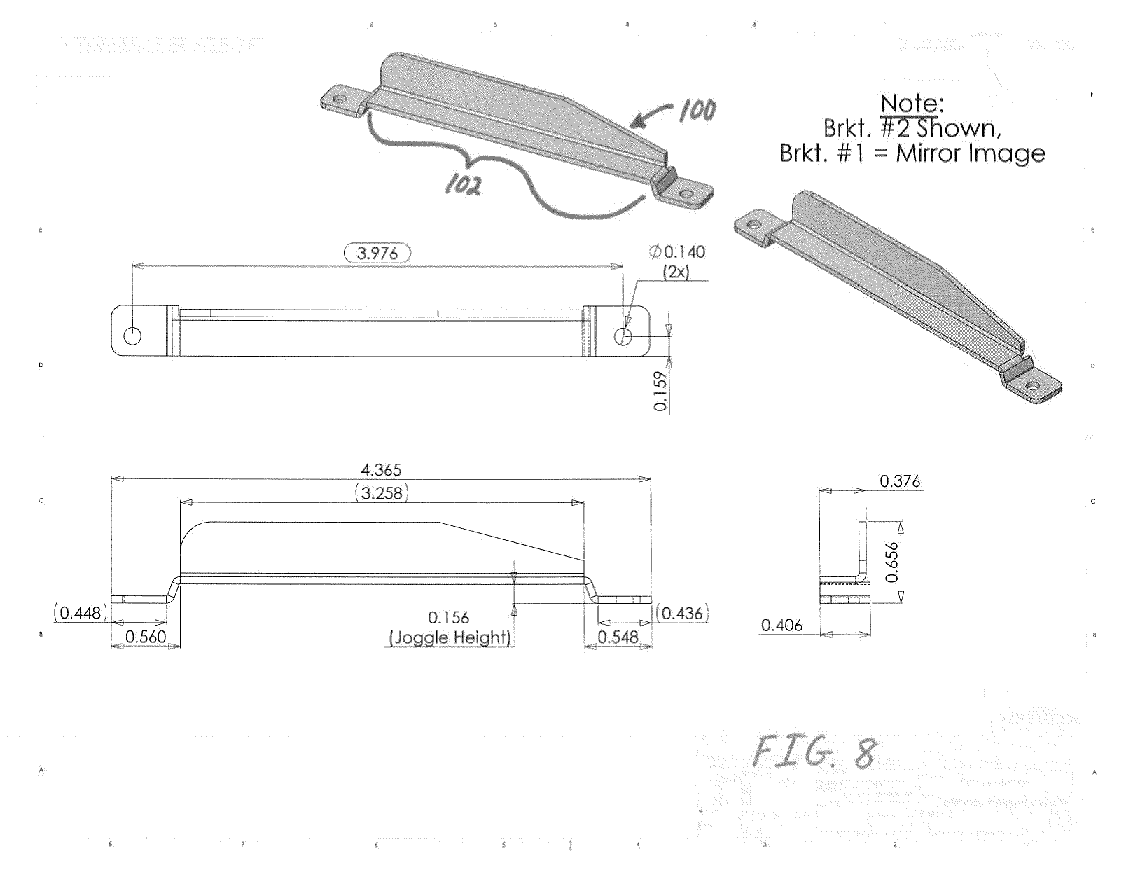

FIG. 9 depicts an engineering spec sheet of one embodiment of a screw end support for a lock assembly that may be used with the lock apparatus.

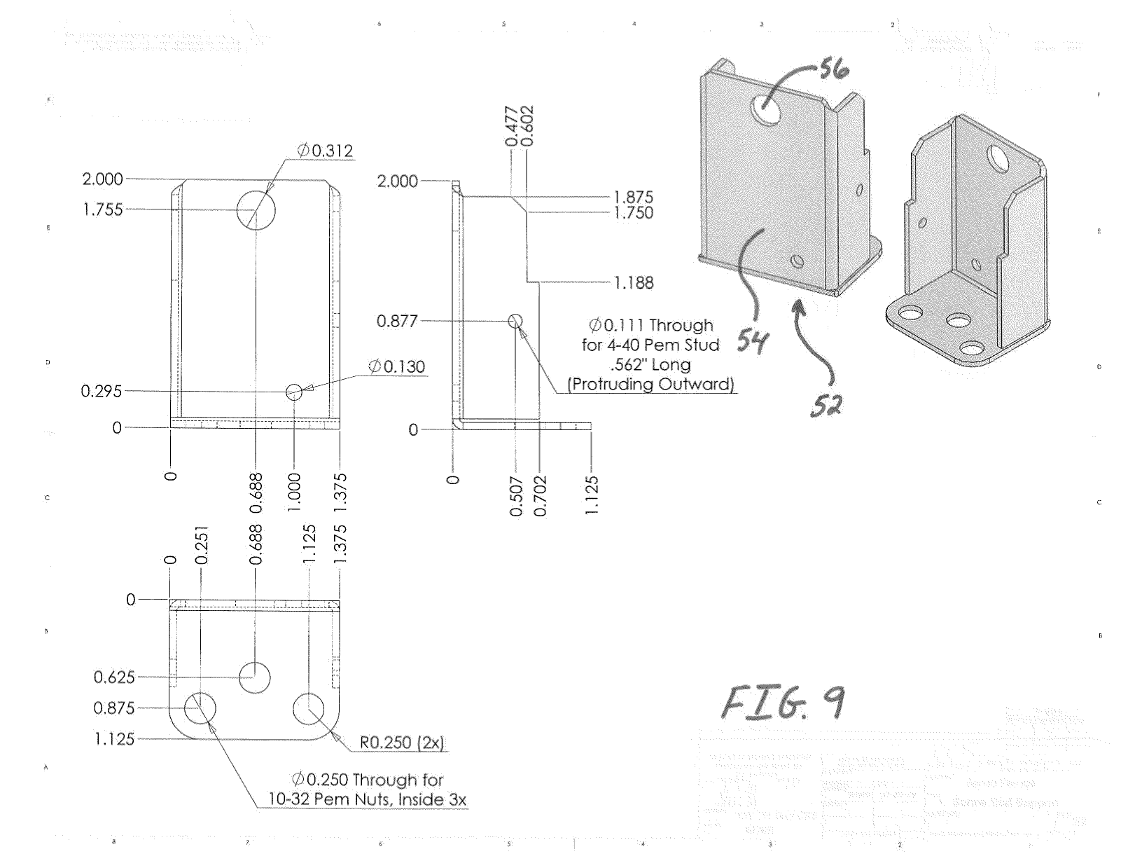

FIG. 10 depicts an engineering spec sheet for one embodiment of a drive screw of a lock assembly that may be used with the lock apparatus.

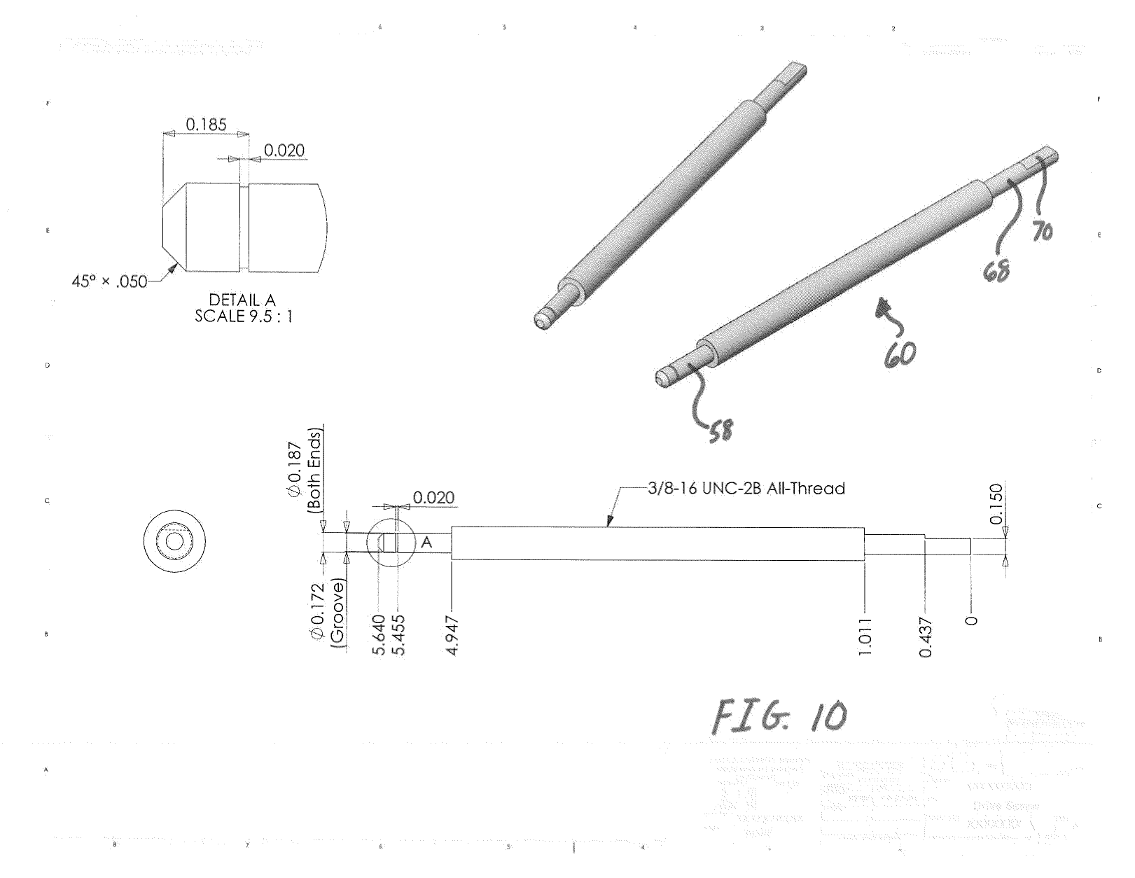

FIG. 11 depicts an engineering spec sheet of one embodiment of a rear spacer mount for a lock assembly that may be used with the lock apparatus.

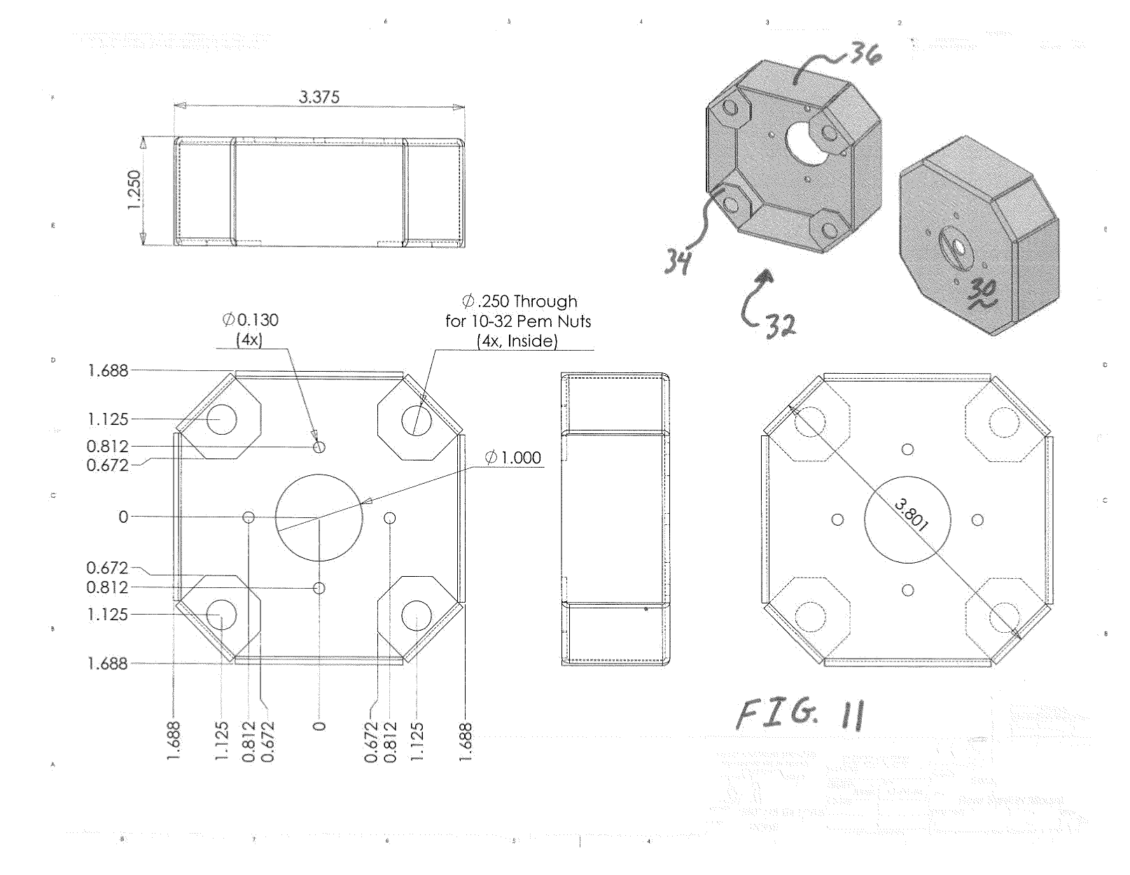

FIG. 12 depicts an engineering spec sheet of one embodiment of a back plate mount for a lock assembly that may be used with the lock apparatus.

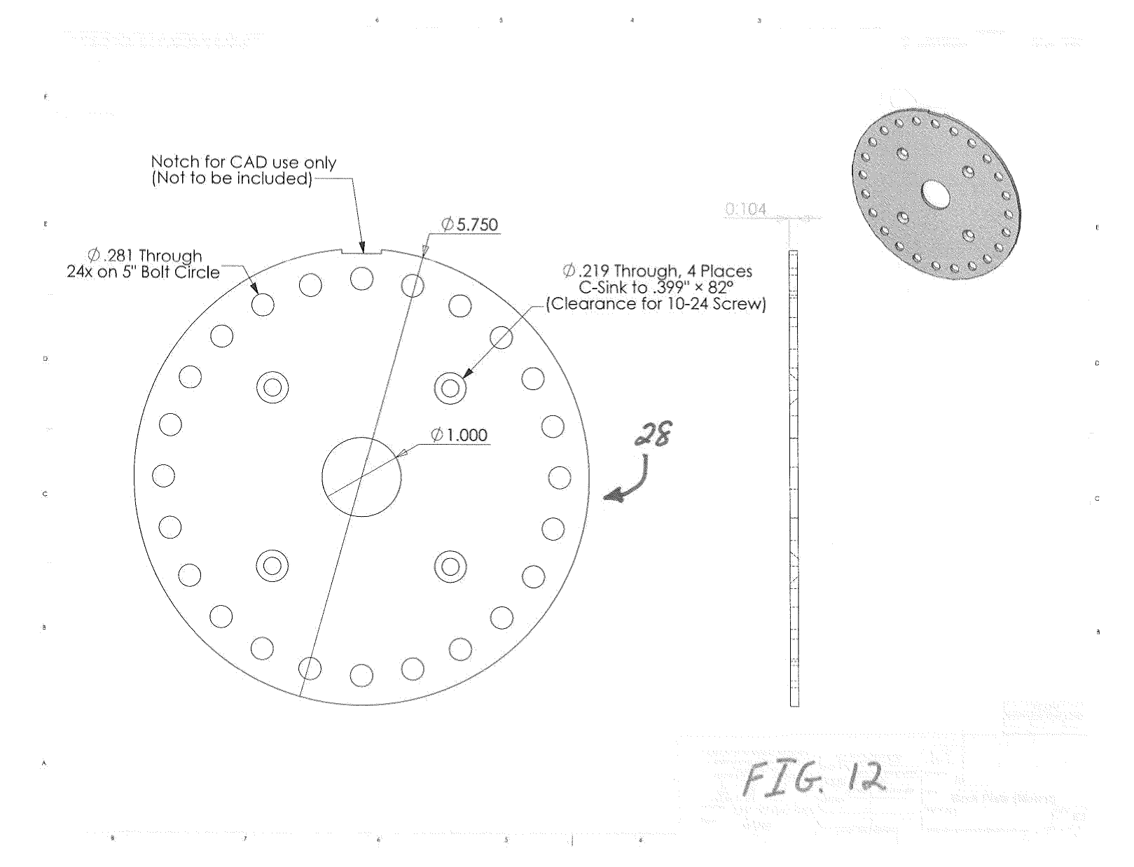

FIG. 13 depicts one embodiment of a support mount of a lock assembly that may be used with the lock apparatus.

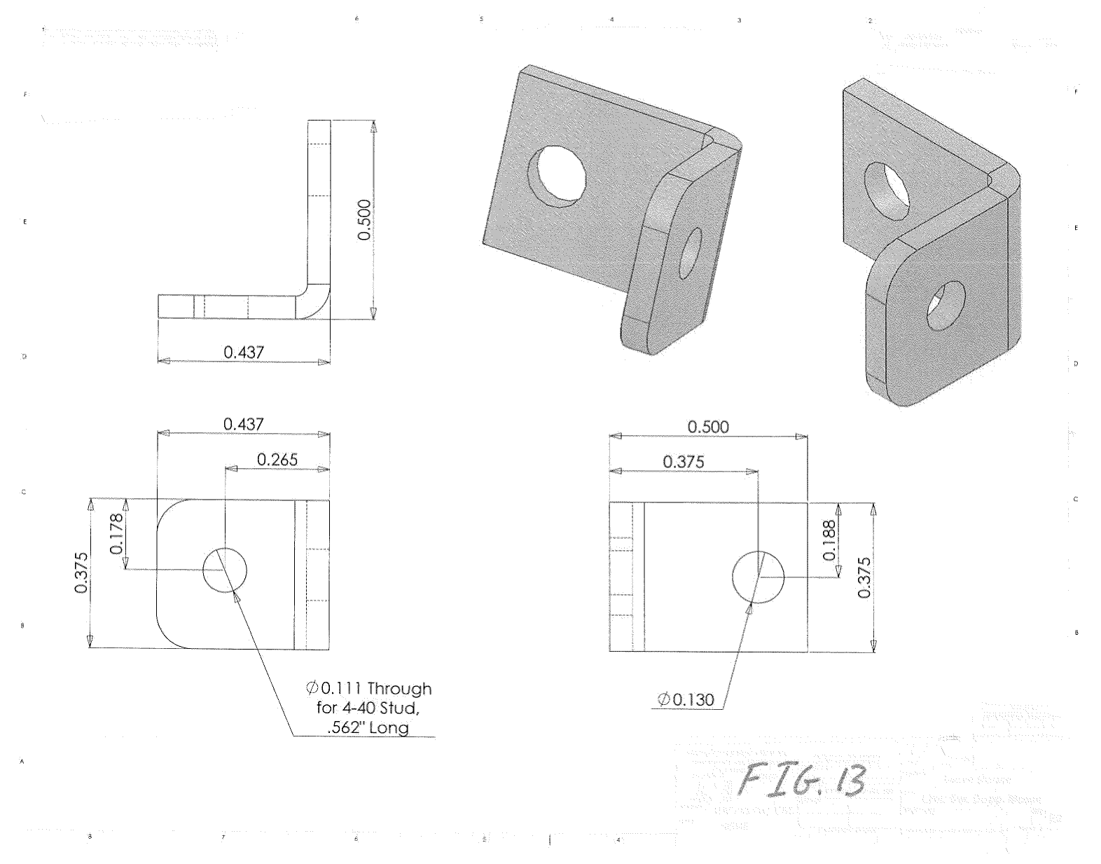

FIG. 14 depicts an alternate embodiment of the lock apparatus in a freestanding form that provides five separate support poles joined by a single hub member.

FIG. 15 depicts a perspective view of a plurality of freestanding lock apparatuses, each having four separate support poles joined by a single hub member.

FIG. 16 depicts another embodiment of the lock apparatus, in a freestanding form, that uses a U-shaped frame to support a plurality of separate support poles.

### DETAILED DESCRIPTION

Embodiments are described more fully below with reference to the accompanying figures, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense.

A lock apparatus 10 and methods of using and fabricating the same are disclosed herein. Generally speaking, the lock apparatus will provide users with storage and security options for a wide array of various articles that may include cycles, skis, fishing tackle, rifles, shotguns, and the like. However, for simplicity of description, examples of the lock apparatus 10 will be described herein as being used to secure and store cycles.

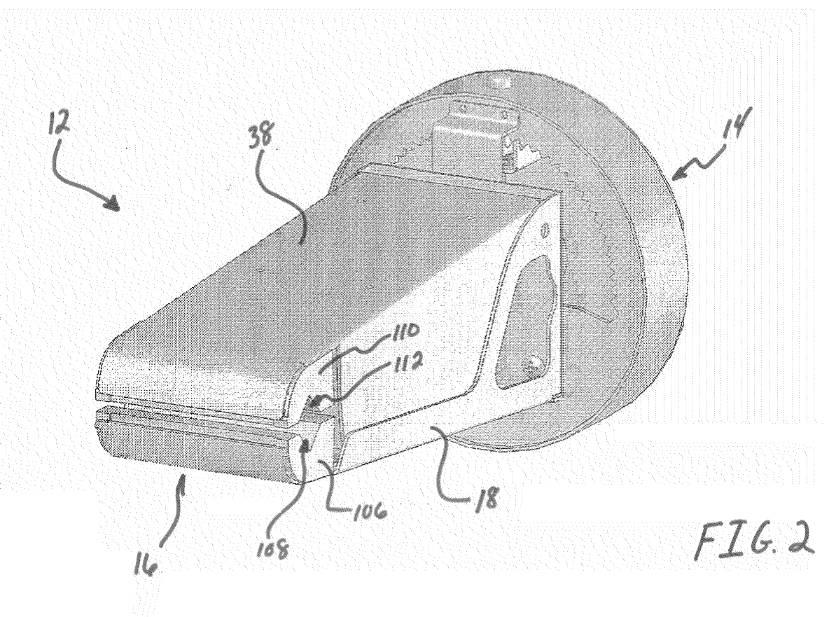

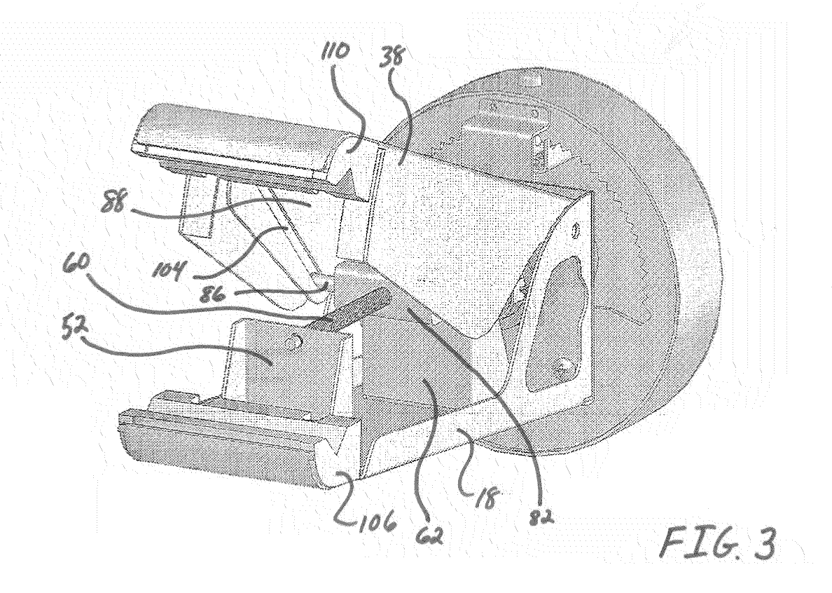

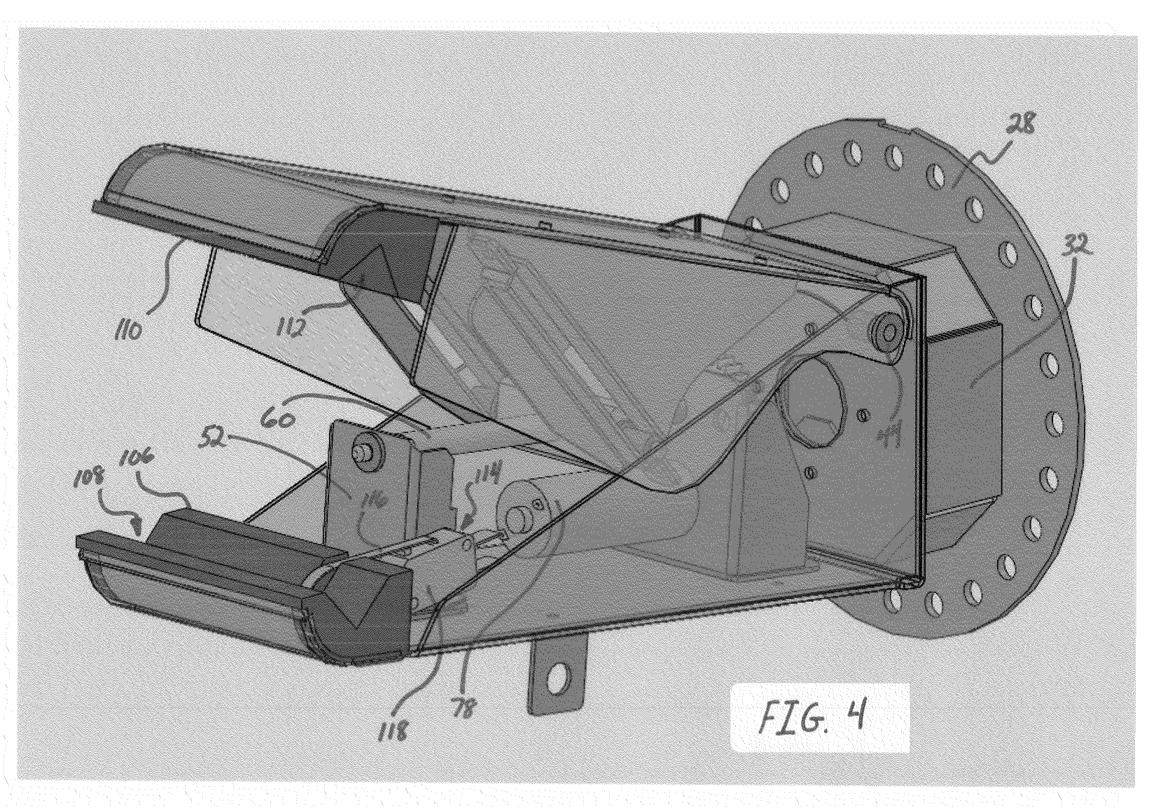

In various embodiments, the lock apparatus 10 will be provided with one or more lock assemblies 12. With reference to FIGS. 2-4, the lock assemblies 12 may be provided in the form of jaw structures that are capable of being moved between closed and opened positions. In some embodiments, the jaw assemblies may be provided to have a long axis that extends between a rearward portion 14 and a forward portion 16 of the lock assemblies 12. In various embodiments, a lower frame member 18 may be provided as a central support member for the lock assembly 12. A lower frame member 18 may be provided with a bottom wall 20, having a length that extends between a rear wall 22 and a forward lip member 24. In some embodiments, the rear wall 22 will extend upwardly from a rearward portion of the bottom wall 20 and be provided with one or more mounting holes 26 that penetrate the rear wall 22. In at least one embodiment, the rear wall 22 may be operatively secured with a back plate mount 28. Alternately, the rear wall 22 may be operatively coupled with a generally planer mounting surface 30 of a rear spacer mount 32. In such embodiments, rear mounting tabs 34 provided along a back side of the rear spacer mount 32 may be used to secure the rear spacer mount 32 with the back plate mount 28. In either respect, the rear wall 22 may be coupled with either the back plate mount 28 or the rear spacer mount using various known fasteners that may include bolts and nuts, screws, and the like. A pair of opposing side walls 36 may be provided to extend upwardly from opposite side portions of the bottom wall 20 and forwardly from opposite side portions of the rear wall 22. In at least one embodiment, the opposite side walls 36 may be shaped to taper downwardly from a rearward portion of the lower frame member 18 toward a forward end portion of the forward frame member 18. Accordingly, such embodiments may result in generally triangular-shaped side walls 36.

In various embodiments, the lock assemblies 12 may each be provided with an upper frame member 38, having a length that extends between a rearward end portion 40 and a lip member 42 formed at the forward end portion of the upper frame member 38. In some embodiments, the rearward end portion 40 of the upper frame member 38 may be pivotably coupled with an upper end portion of the opposing side walls 36 of the lower frame member 18, adjacent the rear wall 22. In at least one embodiment, pivot bushings 44 may be secured within an aperture formed within both the side walls 36 of the lower frame member 18 and the upper frame member 38. In this manner, the lower frame member and upper frame member 38 may be moved between open and closed positions with respect to one another, whereby the lip member 24 of the lower frame member 18 and the lip member 42 of the upper frame member 38 move toward and away from one another, respectively.

Various embodiments of the lock assemblies 12 will be provided with a lower mounting plate 46 that is generally planer in shape, having a length that extends between a rearward end portion 48 and a lip member 50. In some embodiments, the lip member 52 is generally upturned so as to approximate an upturned shape of the lip member 24 of the bottom lower frame member 18. In this manner, a planer portion of the lower mounting plate 46 may be coupled with the bottom wall 20 of the lower frame member 28, permitting the lip member 50 of the lower mounting plate 46 to nest within a curvature of the lip member 24 of the lower frame member 18. In some embodiments, a screw end support 52 may be provided to extend upwardly from the lower mounting plate 46. It is contemplated that the screw end support 52 may be integrally formed with the lower mounting plate 46 or separately fabricated and secured with the lower mounting plate 46 using mechanical fasteners, welding, and the like. Irrespective of its manner of engagement with the lower mounting plate 46, the screw end support 52 will be provided with a support wall 54 that extends outwardly from the lower mounting plate 46. An aperture 56 will be formed through the support wall 54 and sized to receive a first end portion 58 of an elongated drive screw 60.

In some embodiments, the drive screw 60 will be provided with a midsection having a first diameter that extends along a substantial portion of a total length of the drive screw 60. In at least one embodiment, the first end portion 58 of the drive screw 60 may be formed to have a diameter that is less than the first diameter of the mid-portion of the drive screw 60. In this manner, the first end portion 58 of the drive screw 60 may be passed through the aperture 58 of the support wall 44. A retaining clip may be secured within a groove in the first end portion 58 to prevent the unintentional withdraw of the drive screw 60 from within the aperture 56. The increased diameter of the mid-portion of the drive screw 60 will prevent the drive screw 60 from advancing completely through the aperture 56.

A rear screw end support 62 may be provided to extend upwardly from the lower mounting plate 56 in a spaced apart relationship with the screw end support 52, toward the rearward end portion 48 of the lower mounting plate 56. The rear screw end support 62 may be integrally or separately formed with the lower mounting plate 46 and secured therewith using mechanical fasteners, welding and other such procurement methods. The rear screw end support 62 will be provided with a support wall 64 that extends upwardly from the lower mounting plate 46. An aperture 66 will be formed through the support wall 64 and shaped to receive a second end portion 68 of the drive screw 60. The second end portion 68 of the drive screw 60 may be provided with a diameter that is less than that provided for the midsection of the drive screw 60 so that the second end portion 68 of the drive screw 60 may pass through the aperture 66 while preventing passage of the midsection of the drive screw 60. In some embodiments, a key 70 may be formed to extend outwardly from an exterior surface of the second end portion 68.

In various embodiments, the key 70 on the second end portion 68 of the drive screw 60 will be shaped to be received within a corresponding slot formed along an inner wall of an opening that is formed through a first drive gear 72. Teeth, extending radially from a periphery of the first drive gear 72, may be intermeshed with corresponding teeth from a second drive gear 74 positioned adjacent the first drive gear 72. An opening formed through the second drive gear 74 may be operatively coupled with a drive shaft 76 extending from an electric motor 78. To accommodate such an arrangement, a second aperture 80 may be formed through the support wall 64 of the rear screw end support 62. In at least one embodiment, the second aperture 80 is sized to accommodate the passage of the drive shaft 76 but not a diameter of the electric motor 78. In at least one embodiment, the electric motor 78 may be secured with the support wall 64 of the rear screw end support 62 in order to substantially limit rotational movement of the electric motor 78 during its operation.

In some embodiments, a follower block 82 may be provided with an aperture 84 extending transversely through the follower block 82. The aperture 84 may be provided with threads formed along its inner wall that are oriented to engage threads formed along the length of the drive screw 60. Accordingly, rotation of the drive screw 60 in one direction will advance the follower block 82 toward a forward end portion of the lower mounting plate 46, whereas rotation of the drive screw 60 in an opposite direction will advance the follower block 82 in a rearward direction toward the rearward end portion 48 of the lower mounting plate 46. A pair of guide bushings 86 may be provided to extend outwardly from opposite end portions of the follower block 82 so that they extend generally transversely with a long axis of the drive screw 60.

A top sub-carriage plate 88, having a long axis that extends between a rearward end portion 90 and a lip member 92 formed in a forward end portion of the top sub-carriage plate 88, may be associated with the lock assembly 12. In at least one embodiment, the lip member 92 will be shaped to substantially nest within the lip member 42 of the upper frame member 38. The top sub-carriage plate 88 will generally be provided with side walls 94 that extend in a generally perpendicular fashion from a top wall 96 of the top sub-carriage plate 88. In at least one embodiment, lower end portions of the side walls 94 are shaped to have elongated, planer recesses 98. A pair of corresponding follower keeper brackets 100 may be provided to be coupled closely adjacent the recesses 98 in the side walls 94 of the top sub-carriage plate 88. The follower keeper brackets may be formed to have recesses 102 that mirror the recesses 98 so that, when the follower keeper brackets 100 are coupled with the side walls 94, the recesses 98 and 102 form follower slots 104. The resulting follower slots 104 should be sized to slidably receive the guide bushings 86 extending outwardly from the follower block 82. In such embodiments, advancement of the follower block 82, in either a forward or rearward direction, will move the guide bushings 86 along linear paths within the follower slots 104. In some embodiments, the follower slots 104 will be disposed at an angle with respect to the top wall 96 of the top sub-carriage plate 88. More specifically, the follower slots 104 will extend away from the top wall 96 as the follower slots 104 extend from the forward end portion of the top sub-carriage plate 88 to the rearward end portion 90. In at least one embodiment, the follower slots 104 approximate a 45 degree angle with respect to the top wall of 96. Accordingly, as the follower block 82 is advanced in a generally forward direction due to rotation of the drive screw 60, the top sub-carriage plate 88 will be moved toward the lower mounting plate 46, causing the lock assembly 12 to move toward a closed position. Similarly, advancement of the follower block 82 in a generally rearward direction along the drive screw 60 will cause the guide bushings 86 to move downwardly through the follower slots 104, urging the top sub-carriage plate 88 in a generally upward direction. This will cause the lock assembly 12 to move toward an open position.

In various embodiments, a first article support 106 will be coupled within a recess of the lip member 50 of the lower mounting plate 46. The first article support 106 may be provided with an elongated channel 108 having a length that runs along a length of the first article support 106. Accordingly, when the first article support 106 is placed closely adjacent the lip member 50, the channel 108 will extend in a generally transverse fashion with respect to a long axis of the lower mounting plate 46. In some embodiments, a second article support 110 will be positioned within the recess of the lip member 92 of the top sub-carriage plate 88. A generally elongated channel 112 may be formed within the second article support 110 so that a length of the channel 112 extends in a generally parallel fashion with a length of the second article support 110. In this fashion, the channel 112 will extend in a generally parallel fashion with the channel 108 of the first article support 106. The channels 108 and 112 may be positioned so that when the lock assembly 12 is in a closed position, they form a single elongated channel. In this manner, the channels 108 and 112 may be used to secure elongated structures of a tubular fashion, such as portions of a cycle frame. It is contemplated that the first article support 106 and second article support 110 may be formed from a wide array of materials. However, the selection of nonabrasive materials may limit the potential for damage to articles supported by the lock apparatus 10. Moreover, various deformably resilient materials may further prevent the incidence of such damage. Various known plastics and closed cell phones are examples of such suitable materials.

In some embodiments, a strain gauge 114 may be associated with either or both of the first article support 106 and second article support 110. In at least one embodiment, the strain gauge 114 is provided with a deformably resilient arm 116 that extends outwardly from a gauge body 118. In some embodiments, the gauge body 118 is positioned closely adjacent, but to the rear of, the first article support 106. The gauge arm 116 is provided to extend outwardly from the gauge body 118 a sufficient distance to extend at least partially within the channel 108 of the first article support 106. In some embodiments, a slot may be formed in the first article support 106 to accommodate the gauge arm 116 and properly position the gauge arm 116 within the channel 108 so that it is not positioned above an upper surface of the first article support 106. In most embodiments, the strain gauge 114 will be provided to detect deflection of the gauge arm 116 and approximate the force of the deflection. Such deflection and force readings taken by the strain gauge 114 may be relayed to a processor (not shown) associated with the lock apparatus 10. In some embodiments, software associated with the processor will operate the opening and closing of the lock assembly 12, either according to a manual selection by the user or by an automated response to an article being disposed within the channel 108 of the first article support 106. In such embodiments, an article disposed within the channel 108 will engage the gauge arm 116 of the strain gauge 114. Measurements of the force taken by the strain gauge 114 may be relayed to the processor which may then be programmed to actuate the electric motor 78 and close the lock assembly 12 around the article disposed within the channel 108. Conversely, if a user suddenly removes the article from within the channel 108, the strain gauge may be provided to detect a lessening of a deflection of the gauge arm 116. In such an embodiment, the processor may be provided to direct the electric motor 78 to stop or reverse direction to prevent an unintended closure of the lock assembly 12. In still other embodiments, the strain gauge 114 may be provided to measure multiple, successive levels of force. For example, if a cycle frame were placed within the channel 108, a first level of force would be acted upon the gauge arm 116. As the electric motor 78 is actuated and the lock assembly is moved to a closed position, the channel 112 of the second article support 110 will come into contact with an upper surface of the cycle frame. In this manner, it is contemplated that the closure of the lock assembly 12 could cause an additional or second force to be enacted on the gauge arm 116. Detection of such an additional or second force on the strain gauge 114 could be acted upon by causing the processor to stop operation of the electric motor 78 or to slightly reverse its operation, both at a snug but non-damaging force is acted on the article disposed between the first article support 106 and the second article support 110.

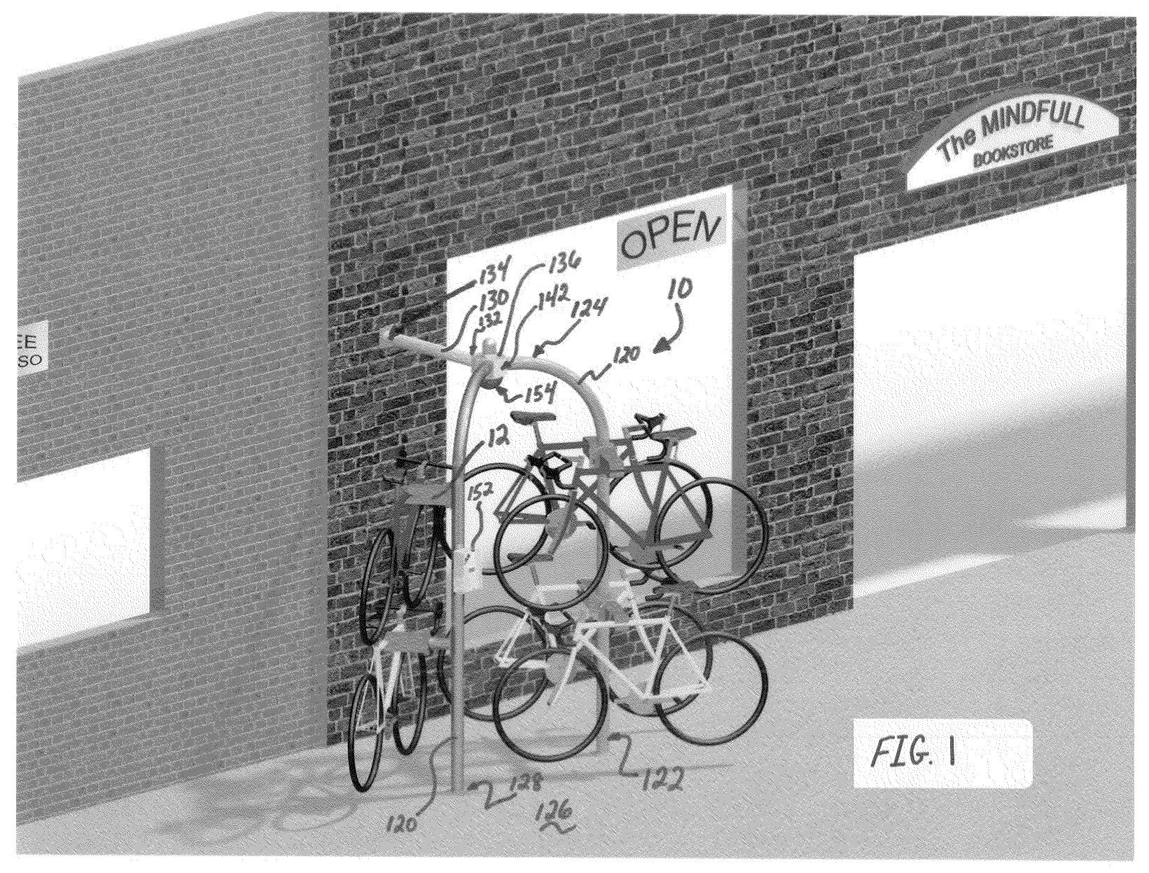

With reference to FIGS. 1 and 14-16, various embodiments of the lock apparatus 10 will provide at least one support member 120 to which one or more lock assemblies 12 may be secured. In some embodiments, the support member 120 is provided in the form of an elongated pole having a first end portion 122 and a second end portion 124. In at least one embodiment, the first end portion 122 of the support member 120 is adapted to be secured with a ground surface 126. The ground surface 126 may be a sidewalk, parking lot, garage floor, or other commonly encountered commercial, public or private spaces in which articles such as cycles may be stored temporarily or long term. In such embodiments, it is contemplated that a flange 128 may be disposed at the second end portion 124 of the support member 120 for engaging the ground surface 126. Bolts or other known mechanical fasteners may be used to secure the flange 128 with the ground surface 126. However, in other embodiments, the first end portion 122 may be secured within the ground surface 126. This may be particularly beneficial where the ground surface 126 is provided in the form of natural ground cover. In still other embodiments, a length of the support member 120 adjacent the first end portion 122 may be at least partially disposed within a manmade ground surface 126, such as concrete, asphalt, or the like, serving as an anchor for the lock apparatus 10. In still other embodiments, however, it is contemplated that the first end portion 122 of the support member 120 may be coupled with a surface other than a ground surface 126. In one example, the first end portion 122 of the support member 120 may be secured to a generally vertical wall member of a building or other static structure. In another example, the first end portion 122 of the support member 120 may be secured with a generally horizontal surface disposed above the ground surface 126, such as a support platform or the like.

It is contemplated that some embodiments of the lock apparatus 10 may leave the second end portion 124 of the support member 120 in a position that is unsecured within a neighboring structure. In such an embodiment, the support member 120 is disposed in a generally freestanding fashion. In other embodiments, an extension arm 130 may be provided to be coupled with the second end portion 124 of the support member 120 at a first end portion 132 and be secured with a static structure at an opposite, second end portion 134. In some embodiments, the first end portion 132 of the extension arm 130 may couple with the second end portion 124 of the support member 120 using an intermediary hub member 136. In various embodiments, the hub member 136 is provided with an upper end portion 138, lower end portion 140 and a peripheral side wall 142 that extends between the upper end portion 138 and the lower end portion 140. While it is contemplated that the second end portion 124 of the support member 120 and the first end portion 132 of the extension arm 130 may be coupled with either of the upper end portion 138, the lower end portion 140, or the peripheral side wall 142 of the hub member 136, some embodiments will secure such structures with facets formed into the peripheral side wall 142. It is contemplated that the hub member 136 may be provided with a peripheral side wall 142 having a generally annular shape. However, the peripheral side wall 142 may also be provided with a plurality of facets. In this fashion, the peripheral side wall 142 may be shaped to provide the hub member 136 with a cross sectional shape resembling any polygon, such as a triangle, square, hexagon, octagon, or the like. Where such generally planer facets are associated with the peripheral side wall 142, it is contemplated that each connecting end portion of either a support member 120 or an extension arm 130 may be coupled with a single, dedicated facet.

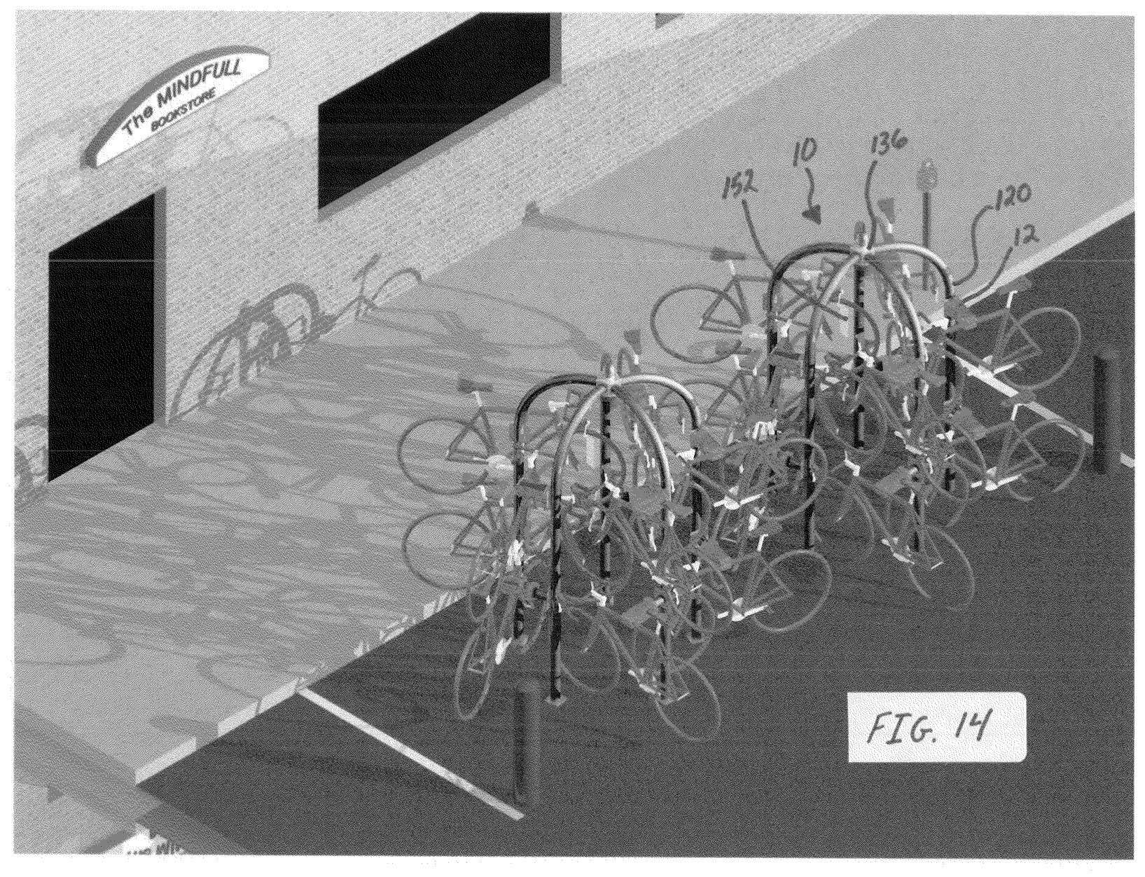

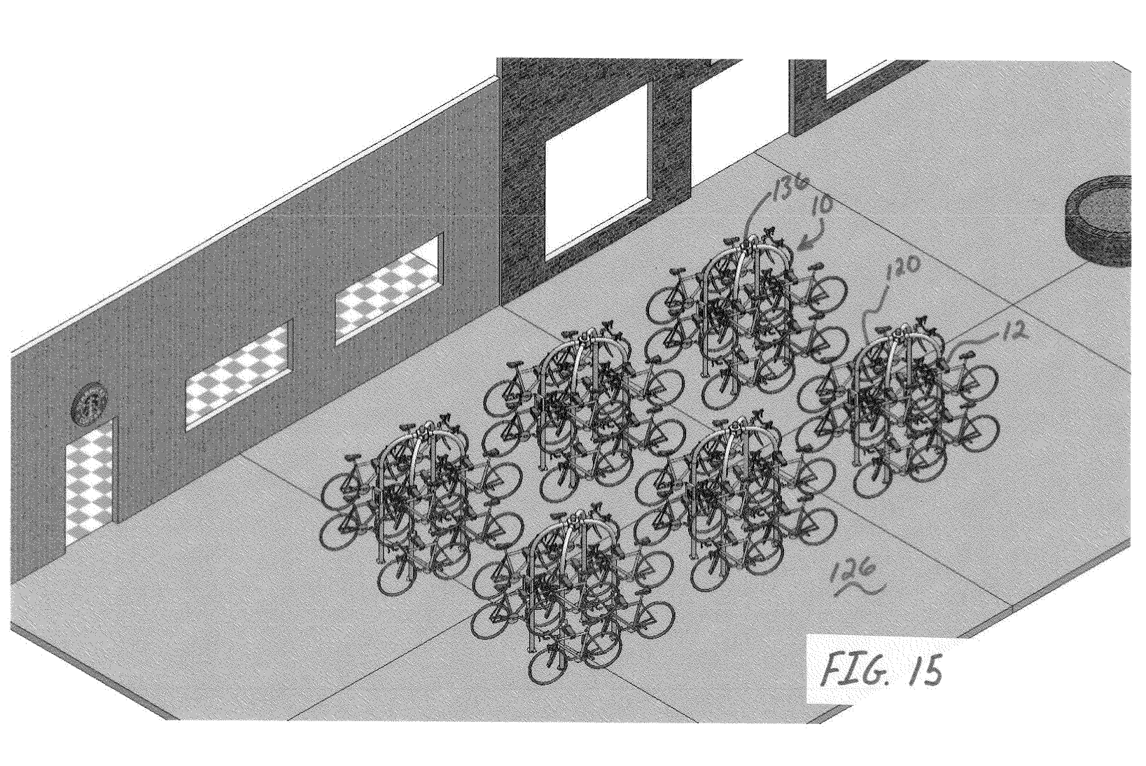

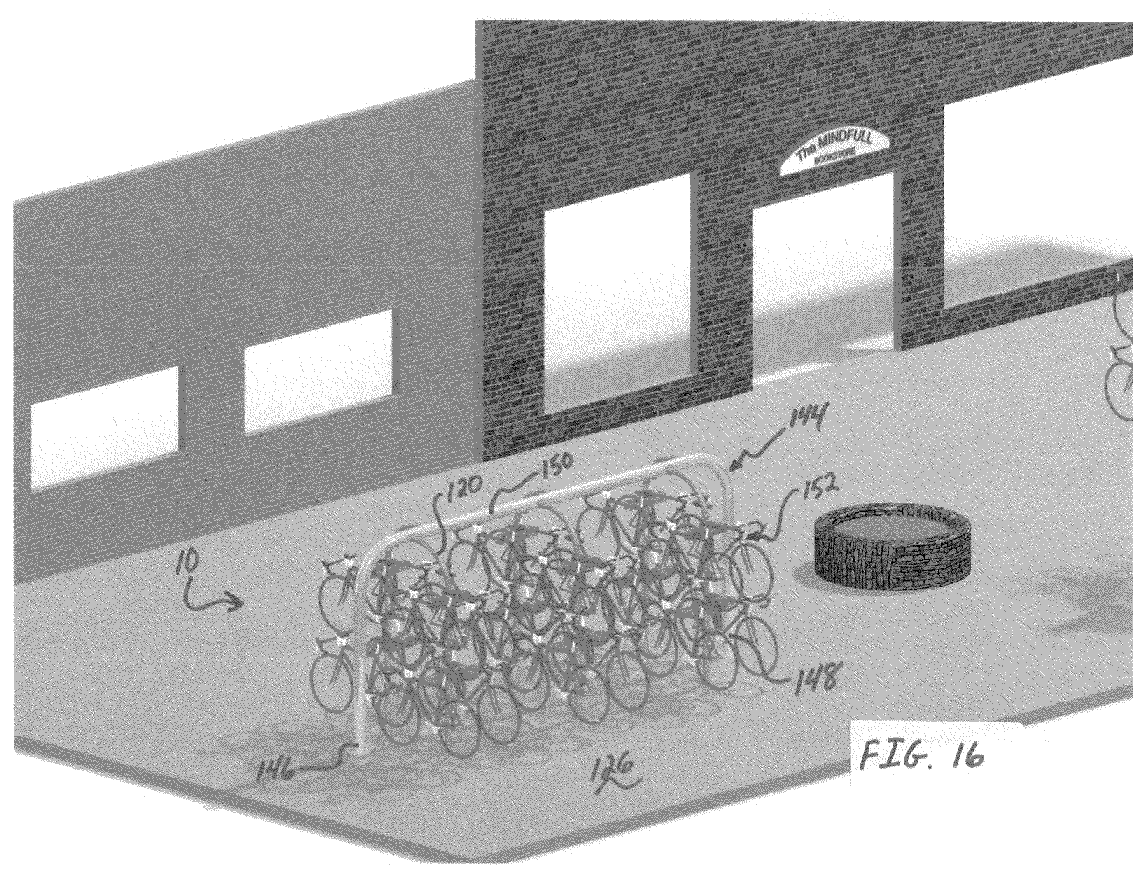

With further reference to FIG. 1, it is contemplated that a multi-faceted peripheral side wall 142 of the hub member 136 may provide an opportunity to couple a plurality of individual support members 120 with one another into a single unit. In such embodiments, a plurality of support members 120 will be coupled with a ground surface 126 at their first end portions 122 in a horizontally spaced apart fashion. The support members 120 may then extend upwardly therefrom. In some embodiments, the second end portions 124 of the support members 120 may be angularly or arcuately disposed so that the terminal ends of the second end portions 124 are disposed at an angle approaching vertical. In this manner, the terminal ends of the second end portions 124 may be secured with facets of the peripheral side wall 142 of the hub member 136. It is contemplated that connection between these structures may be made through mechanical fasteners, welding, and other known methods in the art. A first end portion 132 of the extension arm 130 may be similarly secured with a facet of the peripheral side wall 142 of the hub member 136. With reference to FIG. 14, it is contemplated that more than two support members 120 may join at their second end portions 124 at a single hub member 136. In such embodiments, where, for example, three or more support members 120 couple with a single hub member 136, a level of stability may be provided to the lock apparatus 10 such that an extension arm 130 or other form of structural brace to engage a ground surface 126 or other supporting structure may be unnecessary. For example, FIG. 14 depicts a pair of lock apparatuses 10 that are positioned next to one another in a freestanding fashion within a parking lot, adjacent a sidewalk. With reference to FIG. 15, six lock apparatus 10 are provided in a freestanding fashion to extend upwardly from a sidewalk or other pathway. The lock apparatus 10 of FIG. 15 is depicted as having four support members 120 for each lock apparatus 10. With reference to FIG. 16, other embodiments of the lock apparatus 10 may provide a support frame 144 that is secured at one or more points with a ground surface 126, and adjacent wall, or other supporting structure. The exemplary embodiment depicted in FIG. 16 is provided with a generally U-shaped support frame 144, having a first end portion 146 and a second end portion 148, which are both secured with the ground surface 126. It is contemplated that the end portions of the support frame 144 may be secured with a supporting structure in much the same way as that described previously with respect to the first end portion 122 of the support members 120. The exemplary support frame 144 is provided to extend upwardly from the ground surface 126 at its first end portion 146 and second end portion 148. These “legs” then bend toward one another to provide a generally horizontally disposed support arm 150. In some embodiments, the support arm 150 will provide an adequate mounting structure to receive the second end portions 124 of one or more support members 120. In the exemplary embodiment depicted, six support members 120 are coupled with the support arm 150, with three support members 120 being secured to one side of the support arm 150 and three support members 120 being secured to an opposite side of the support arm 150.

In various embodiments, the support member 120, extension arm 130, and support frame 144 may be formed from various diameters of tubing, having an open internal passageway extending between the end portions thereof. In such embodiments, electrical lines, communication network lines and the like, may be provided to extend outwardly from a building or from a ground surface 126 to properly supply a lock apparatus 10 with necessary power and communications access. While it is contemplated that one or more electrical systems associated with the lock apparatus 10 may be provided in a hard-wired state with respect to a surrounding electrical grid, it is contemplated that one or more backup batteries may be associated with the lock apparatus 10 during periods of power outage. In various embodiments, such batteries may be disposed within the support member 120, extension arm 130, or support frame 144. However, the hub member 136 may be provided to have a generally open interior cavity to support backup batteries, processors, and further permit the passage of power in communication lines between adjacent structures.

It is contemplated that various embodiments of the support members 120 will provide for different lengths of these support members 120 so that the lock apparatus 10 may extend nearly any desired distance away from a ground surface 126 or an adjacent support structure. In various embodiments, the support member 120 may be provided in a length that enables a two level securement of articles, such as cycles. With reference to FIGS. 1 and 14-16, the support members 120 may each be provided with one or more lock assemblies 12. Where a plurality of lock assemblies 12 are associated with a single support member 120, it is contemplated that the lock assemblies 12 may be secured with the support member 120 to extend outwardly therefrom in different directions at the same or similar level above the ground surface 126. However, it is contemplated that the multiple lock assemblies 12 may be provided in a vertically spaced apart fashion to provide at least a second tier above the ground surface 126. While vertical spacing between the lock assemblies 12 may vary according to the intended use and the articles to be stored, it is contemplated that the vertical separation between the ground surface 126 and a first tier of lock assembly 12, and then between that tier and a second tier of lock assembly 12, will approximate an average riding height for a top frame member of a cycle of approximately 28 to 38 inches. In this manner, a pair of cycles may be supported in a vertically spaced relationship with one another along a single side of a support member 120. With further reference to FIGS. 1 and 14-16, however, orientation of multiple support members 120 with respect to one another may dictate the number and orientation of lock assemblies 12 that extend outwardly from the support members 120 to provide easy access for users to their articles and limit interference between the articles as they are engaged with and removed from the lock apparatus 10.

In various embodiments, the lock assemblies 12 may be secured with the support members 120 using standard mechanical fasteners, such as bolts, screws, and the like. In such embodiments, the fasteners may be passed through openings that are formed through the rear spacer mount 32 (when used) and the back plate mount 28. In some embodiments, these openings are positioned to be only accessible to an installer when the “jaws” of the lock assembly 12 are provided in an open position. Accordingly, this will limit the ability of thieves from disengaging the lock assemblies 12 from the support members 120. In still other embodiments, welding and other such fastening techniques may be used to secure the lock assemblies 12 with the support members 120.

In various embodiments, a tether (not depicted) may be associated with the lock assembly 12. In some embodiments, the tether may be provided with opposite end portions, with one end being secured with either the lock assembly 12 or an adjacent structure, such as the support member 120. In at least one embodiment, the opposite end portion of the tether will be selectively securable with either a portion of the lock assembly 12 or an adjacent structure, such as the support member 120. It is contemplated that the tether may be comprised of a rigid cable of durable material, such as braided steel and the like, to limit the likelihood of an individual cutting the tether to steal articles secured therewith. However, in other embodiments, an electrical line may be disposed to run the length of the tether that is coupled with a power supply to the lock apparatus 10. The electrical line may further be electrically coupled with one or more processors associated with the lock apparatus 10. In such arrangements, the processor may be provided with software that is capable of reading a current or “open line” condition of the electrical line. The software may be provided to relay an alarm warning where power is no longer provided to the electrical line within the tether or that the electrical line within the tether has been severed. It is contemplated that the tether may be provided with a length that allows users to easily secure separate articles therewith. In some embodiments, users may secure bike helmets, bike seats, wheels, and the like thereto.

In various embodiments, a pay point 152 may be associated with the lock apparatus 10. In some embodiments, the pay point 152 will be provided with a keypad, or other known input device, and a display for presenting information and feedback to a user. In still other embodiments, the pay point 152 may include an electromagnetic card reader and associated sensors to enable the pay point 152 to read the magnetic strips commonly found on credit cards, ID cards, proprietary cards, and the like. Accordingly, in various embodiments, the pay point 152 will be provided with a processor, having software that is operative on the processor to receive input from a keypad, or other such input device, and/or the electromagnetic card reader. In some embodiments, software may be associated with the processor to determine that a particular validated single is received from a user. In some instances, the validation may come in the form of a payment from a creditor debit card. In other instances, the validation may come from a proprietary card associated with an operator of the lock apparatus 10. Irrespective of the source of validation, it is contemplated that a proper validation may cause the software to operate on the processor within the pay point 152 to send a signal to one or more lock assemblies 12, causing the jaws of the lock assembly 12 to open. In this scenario, a user may then place an article closely adjacent the first article support 106 in some embodiments, such as where a strain gauge 114 is used and senses the receipt of the user's article, the lock assembly 12 may be provided to automatically close and secure the article therein. In other embodiments, input from the user at the pay point 152 may be required to manually select the electronic closure of the lock assembly 12. Alternatively or in addition to the described functions for the pay point 152, authentication from one or more users may be entered into the pay point 152 through the use of a biometric sensor that is associated with the lock apparatus 10. In at least one embodiment, the association may be provided directly with the pay point 152. In other embodiments, however, a separate module may be associated with the lock apparatus 10. Irrespective of its point of association, the biometric sensor may be used to receive input of a user's personal features, such as the user's fingerprints, retina, face, voice and comparing the inputted personal features against a stored data file containing the personal feature characteristics of authorized users located on a processor. Where the input from the sensor matches the personal features of an authorized user stored in the file, an unlock signal may be generated by the processor to open the lock assembly 12.

Various embodiments of the lock apparatus 10 will incorporate one or more different security measures to protect against the theft of articles stored by the lock apparatus 10. In some embodiments, sensors may be associated with one or more components of the lock apparatus 10. For example, one or more vibration sensors may be associated with the lock assembly 12, the support member 120, or the like. The level of sensitivity may be adjusted within such vibration sensing modules to deliver a level of desired vibration monitoring. Such monitoring may be able to detect undesired tampering with the lock apparatus 10 or any of the articles stored thereon. Another such sensor may include simple open and closed switch sensors that may be closely associated with components of the lock assembly 12 to determine if and when the lock assembly 12 has been forced into an open position without engagement of the electric motor 78 in a common, approved fashion. Still another sensor that may be associated with the lock apparatus 10 includes a power available sensor that may be electrically coupled with a power supply to the lock apparatus 10. Such a sensor will commonly trip a warning signal where the voltage supply drops below a predefined level or is discontinued entirely. Irrespective of the type of security sensor used, each such sensor will produce an anomaly or warning signal. Accordingly, such sensors and modules may be electrically coupled with a central processor within the lock apparatus 10 that should be provided with software capable of receiving and determining the type of signal received. In such embodiments, the processor may be associated with a network connection that enables the lock apparatus 10 to transmit the anomaly or warning signal to a point remotely positioned from the lock apparatus 10. For example, a processor within the lock apparatus 10 may be provided with access to a network or wireless mesh network. Either such network may include a local area network and a wide area network, but may also include other proprietary and nonproprietary networks, such as wireless networks, a PSTN, the Internet, and intranet, and the like. Irrespective of the network connections used by the lock apparatus 10, the processor may be provided with data enabling it to transmit the anomaly or warning signal to one or more of a central system operator, a personal contact (such as a telephone number, e-mail address, or the like) of a user, the police, or other security agency.

In various embodiments, the security systems afforded to the apparatus 10 may provide local alarm notification along with, or alternative to, the transmission of anomalies or warning signals to a remote location. In at least one embodiment, a visual warning system, such as a strobe light 154 or other light emitting source, may be coupled with the lock apparatus 10. Similarly, an audible alarm, such as a siren or the like, may be associated with the lock apparatus 10 by electrically coupling a horn or other speaker with a central processor that receives the anomalies or warning signals. In still another embodiment, the security circuitry associated with the lock apparatus 10 may be provided to disable the electric motor 78, significantly reducing the likelihood that the lock assembly 12 may be opened, allowing access to the accessories stored thereon. It is further contemplated that still or video surveillance of the area associated with the lock apparatus 10 may be provided; such surveillance may be recorded and/or provided as a live feed to one or more monitoring stations remote from the lock apparatus 10. And, yet, another embodiment, a GPS module may be located within components of the lock apparatus 10 and associated with a backup battery supply. In this instance, the GPS module may also be associated with a transmitter provided for use by other systems within the apparatus 10 or a dedicated transmitter for relaying a location signal. In this instance, the GPS location signal may be used as a tracking device where the lock apparatus 10 is completely removed from the ground surface 126 or other associated mounting structures and transported to a remote location.

It can thus be seen that the foregoing cycle lock apparatus provides both cycle storage and security in one apparatus. The apparatus is relatively easy to use, strong, long lasting, and economical and easy to manufacture, install, or re-install if needed. It can help reduce the possibility of damage to an associated cycle when mounted in the apparatus, even when the apparatus is subject to tampering. It also provides alarms for various types of tampering or possible damage to the apparatus or associated cycle, and the alarms may be contained within the apparatus or provided by separate alarm systems, such as a building alarm system with which the apparatus may readily be adapted to communicate, including wirelessly, if desired. In addition, the cycle lock apparatus may provide a convenient and reliable support for working with or maintaining a cycle mounted in the apparatus.

Although the system 10 has been described in language that is specific to certain structures, materials, and methodological steps, it is to be understood that the invention defined in the appended claims is not necessarily limited to the specific structures, materials, and/or steps described. Rather, the specific aspects and steps are described as forms of implementing the claimed invention. Since many embodiments of the invention can be practiced without departing from the spirit and scope of the invention, the invention resides in the claims hereinafter appended. Unless otherwise indicated, all numbers or expressions, such as those expressing dimensions, physical characteristics, etc. used in the specification (other than the claims) are understood as modified in all instances by the term “approximately.” At the very least, and not as an attempt to limit the application of the doctrine of equivalents to the claims, each numerical parameter recited in the specification or claims which is modified by the term “approximately” should at least be construed in light of the number of recited significant digits and by applying ordinary rounding techniques. Moreover, all ranges disclosed herein are to be understood to encompass and provide support for claims that recite any and all subranges or any and all individual values subsumed therein. For example, a stated range of 1 to 10 should be considered to include and provide support for claims that recite any and all subranges or individual values that are between and/or inclusive of the minimum value of 1 and the maximum value of 10; that is, all subranges beginning with a minimum value of 1 or more and ending with a maximum value of 10 or less (e.g., 5.5 to 10, 2.34 to 3.56, and so forth) or any values from 1 to 10 (e.g., 3, 5.8, 9.9994, and so forth).

What is claimed is:

1. A securement system, the system comprising:
a lock assembly that includes a lower frame member and an upper frame member that is operatively pivotably coupled to the lower frame member, whereby the lower frame member and lower frame member are movable between open and closed positions with respect to one another;
a forward end portion of the lock assembly including open channels that are positioned transversely with respect to the lower and upper frame members and face one another at least when the lower and upper frame members are in the closed position;
a rearward end portion of the lock assembly being operatively coupled with a support member and oriented to support the lock assembly above an operating surface; the support member extending away from the operating surface.

2. The securement system of claim 1 wherein the lock assembly further includes:
a lower mounting plate coupled with the lower frame member;
a drive screw operatively coupled with the mounting plate;
a motor operatively coupled with the drive screw, whereby actuation of the motor rotates the drive screw;
a follower bock coupled with the drive screw and movable along a length of the drive screw whereby rotation of the drive screw advances and withdraws the follower block along the length of the drive screw; the follower block being operatively coupled with the upper frame member whereby movement of the follower block along the length of the drive screw move the lower and upper frame members between the open and closed positions.

3. The securement system of claim 2 wherein the lock assembly further includes:
a top sub-carriage plate located between the upper frame member and the lower mounting plate; the top sub-carriage plate including at least one recess; and
guide bushings that extend from said follower block and travel within the at least one recess of the top sub-carriage plate when the lower and upper frame members move between the open and closed positions.

4. The securement system of claim 2, wherein the lower frame member further comprises a lower forward lip member and wherein the lower mounting plate further comprises a lip member, the lip member of the lower mounting plate formed to fit within a lower forward lip member of the lower frame member.

5. The securement system of claim 4, wherein the lower frame member comprises a bottom wall, opposing side walls and the lower forward lip member.

6. The securement system of claim 5, wherein the upper frame member further comprises an upper forward lip member and wherein the top sub-carriage plate further comprises a lip member, the lip member of the top sub-carriage plate formed to fit within the lip member of the upper frame member.

7. The securement system of claim 6, further comprising a first article support operatively coupled to the lip member of the lower mounting plate; at least one of the open channels of the lock assembly being formed along a length of the first article support.

8. The securement system of claim 7, further comprising a second article support operatively coupled to the lip member of the top sub-carriage plate; at least one of the open channels of the lock assembly being formed along a length of the second article support.

9. The securement system of claim 8, further comprising a strain gauge, operatively coupled to the first article support, whereby a portion of a gauge arm of the strain gauge extends into the channel formed within the first article support.

10. The securement system of claim 1 wherein the support member is secured with the operating surface and extends outwardly therefrom.

11. The securement system of claim 10 comprising a plurality of lock assemblies coupled with the support member in a spaced-apart relationship with one another along a length of the support member.

12. The securement system of claim 1 wherein the lock assembly is rotatably coupled with the support member whereby the channels may be selectively rotated with respect to the operating surface.

13. The securement system of claim 2 further comprising:
an electronic pay point that includes a processor and software operative on the processor to receive electronic payment information;
the electronic pay point being electrically coupled with the motor of the lock assembly;
the software being further operative on the processor to send a signal that causes the motor to open or close the lock assembly.

14. The securement system of claim 10 further comprising:
an electronic pay point that includes a processor and software operative on the processor to receive electronic payment information;
the electronic pay point being electrically coupled with the motor of the lock assembly;
the software being further operative on the processor to send a signal that causes the motor to open or close the lock assembly;
the software being further operative on the processor to receive a signal from the strain gauge and cause the motor to permit closure of the lock assembly in response to the signal received from the strain gauge.

15. A method for securing an article comprising:
providing a lock assembly that includes a lower frame member and an upper frame member that is operatively pivotably coupled to the lower frame member, whereby the lower frame member and lower frame member are movable between open and closed positions with respect to one another;
providing a forward end portion of the lock assembly including open channels that are positioned transversely with respect to the lower and upper frame members and face one another at least when the lower and upper frame members are in the closed position;
providing a rearward end portion of the lock assembly being operatively coupled with a support member and oriented to support the lock assembly above an operating surface; the support member extending away from the operating surface.

16. The method of claim 15, further comprising:
providing a lower mounting plate coupled with the lower frame member;
providing a drive screw operatively coupled with the mounting plate;
providing a motor operatively coupled with the drive screw, whereby actuation of the motor rotates the drive screw;
providing a follower bock coupled with the drive screw and movable along a length of the drive screw whereby rotation of the drive screw advances and withdraws the follower block along the length of the drive screw; the follower block being operatively coupled with the upper frame member whereby movement of the follower block along the length of the drive screw move the lower and upper frame members between the open and closed positions.

17. The method of claim 16, further comprising:
providing a lock assembly further including:
a top sub-carriage plate located between the upper frame member and the lower mounting plate; the top sub-carriage plate including at least one recess; and
guide bushings that extend from said follower block and travel within the at least one recess of the top sub-carriage plate when the lower and upper frame members move between the open and closed positions.

18. The method of claim 16, further comprising:
providing a lower frame member further comprising a lower forward lip member and wherein the lower mounting plate further comprises a lip member, the lip member of the lower mounting plate formed to fit within a lower forward lip member of the lower frame member.
